(19) United States
(12) Patent Application Publication
(10) Pub. No.: US 2009/0174936 A1
(43) Pub. Date: Jul. 9, 2009

(54) MICROSCOPE ARRAY FOR MULTANEOUSLY IMAGING MULTIPLE OBJECTS

(75) Inventor: ARTUR G. OLSZAK, Tucson, AZ (US)

Correspondence Address: ANTONIO R. DURANDO, 6902 N. TABLE MOUNTAIN ROAD, TUCSON, AZ, 85718-1331, US

(73) Assignee: DMetrix, Inc., Tucson, AZ (US)

(21) Appl. No.: 12/365,779

(22) Filed: Feb. 4, 2009

Related U.S. Application Data
(63) Continuation of application No. 10/191,679, filed on Jul. 8, 2002, now abandoned.
Application No. 10/191,679 is a continuation-in-part of application No. 12/002,107, filed on Dec. 14, 2007.
Application No. 12/002,107 is a continuation-in-part of application No. 11/711,283, filed on Feb. 27, 2007.
Application No. 11/711,283 is a continuation-in-part of application No. 10/637,486, filed on Aug. 11, 2003, now Pat. No. 7,184,610.
Application No. 10/637,486 is a continuation of application No. PCT/US02/08286, filed on Mar. 19, 2002.
(60) Provisional application No. 60/276,498, filed on Mar. 19, 2001.

(51) Int. Cl. G02B 21/18

(52) U.S. Cl. 359/373

(57) ABSTRACT

A microscope array for simultaneously imaging multiple objects. A preferred embodiment of a method according to the invention includes arranging the objects into an array, providing a microscope array having a plurality of imaging elements with respective fields of view arranged into a corresponding array such that the imaging elements are optically aligned respectively with the objects, and simultaneously imaging the objects with the microscope array to produce respective images of the objects. The invention also provides for scanning while imaging, and for stepping and repeating the imaging process.

### RELATED APPLICATIONS

This application is a continuation application of U.S. Ser. No. 10/191,679, filed Jul. 8, 2002, entitled Microscope Array for Simultaneously Imaging Multiple Objects. This application is also a continuation-in-part application and claims the priority of U.S. Ser. No. 12/002,107, filed Dec. 14, 2007, entitled Large-Area Imaging by Concatenation with Array Microscope, which is a CIP of U.S. Ser. No. 11/711,283, filed Feb. 27, 2007, entitled Slide-Borne Imaging Instructions, which is a CIP of U.S. Ser. No. 10/637,486, filed Aug. 11, 2003, entitled Miniaturized Microscope Array Digital Slide Scanner, now U.S. Pat. No. 7,184,610, which is a continuation of PCT/US02/08286, filed Mar. 19, 2002, which claims the benefit of priority of U.S. Provisional Application No. 60/276,498, filed Mar. 19, 2001.

### BACKGROUND OF THE INVENTION

1. Field of the Invention

This invention relates to microscopy, and particularly to simultaneously imaging multiple objects with a microscope array comprising a plurality of microscope optical imaging elements.

2. Description of the Prior Art

Microscopes have often been used to scan specimens of various kinds to obtain a plurality of microscopic images of all or a portion of the specimen. The specimens may be, for example, biological or biochemical samples, or inorganic mineral samples. Typical scanning microscopes operating in the visible spectrum have been discrete sequential imaging devices. In sequential imaging, a first object, or a portion of an object, is imaged and then moved out of the microscope's field of view, and a subsequent object, or portion of an object, is thereafter moved into the microscope's field of view and imaged, and so forth. Although sequential scanning can be used to obtain a plurality of discrete, two-dimensional microscopic images of an object which are thereafter stitched together to form a microscopic image of a larger portion of the object, such scanning is best suited for taking microscopic images of a plurality of independent objects sequentially where the image acquisition rate is not critical.

Recently, a type of scanning miniature microscope array, also known as an array microscope, has been developed for obtaining a microscopic image of all, or a large portion, of a relatively large object. This is done by scanning the object line-by-line in one direction with an array of optical elements having respective linear arrays of detectors distributed in a direction perpendicular to the scan direction. The data are captured digitally and mapped to their respective positions to produce a digital microscopic image representation of all or the large portion of the object. Ordinarily, the optical elements would have a large numerical aperture to produce high resolution, but a relatively small field of view and a relatively large image size. Thus, the elements selected to scan contiguous points along a given line must be offset in the direction perpendicular to the scan direction. The scanning array microscope permits faster data acquisition than a sequential, discrete scanning microscope and avoids having to stitch discrete two-dimensional images together, but is directed to obtaining a microscopic image of a single object or portion thereof.

A significant application of discrete sequential imaging is scanning of microarrays—a standard vehicle for biochemical analysis such as DNA testing, protein marking and the like—for which a large number of independent “cells” need to be imaged. A microarray is an aggregate of multiple cells disposed on a single substrate. The cells are used, for example, to observe chemical reactions or to test for specific gene sequences. Each cell contains some material that carries useful information that can be retrieved using suitable microscopy techniques, such as, for example, bright field microscopy, dark field microscopy and fluorescence microscopy. The cells are ordinarily arranged on a rectangular grid for ease of handling. The spacing of the cells can range from a few hundred micrometers to several millimeters. For example, experiments have been conducted with living cell cultures having a diameter on the order of 100 micrometers and a spacing of 250 micrometers. Scanning is accomplished by using mechanical or optical devices to advance the microscope or cell to the next sample location.

Microarrays are particularly suitable for discrete sequential scanning microscopy because of the independence of the cells; that is, they are independent objects for which respective two-dimensional images may be acquired in sequence. However, tests of a large volume of cells are typically needed for useful analysis, which makes it desirable to maximize the image acquisition rate so as to produce useful results in the minimum time and with minimum cost.

Accordingly, there is an unfulfilled need for methods and devices for increasing the data acquisition rate in imaging multiple objects, such as the cells of a microarray, so as to minimize the time for acquiring images of all of the objects.

### BRIEF SUMMARY OF THE INVENTION

The present invention meets the challenge of providing for simultaneous imaging of multiple independent objects by arranging the objects into an array, providing a microscope array having a plurality of imaging elements arranged in a corresponding array such that a plurality of the imaging elements may be optically aligned with respective independent objects, and simultaneously imaging the respective objects with the microscope array to produce respective discrete, two-dimensional images of the objects. All or a selected subset of the objects may be imaged simultaneously. Where only a subset of the objects is imaged simultaneously, sequential scanning of such subsets may be used to image a larger set of the objects to meet physical or cost constraints. Scanning may solely employ two-dimensional imaging object-by-object, or the objects may be individually and simultaneously scanned line-by-line by respective one-dimensional sub-arrays of detectors in one dimension as well.

Accordingly, it is a principle object of the present invention to provide a novel microscope array system for simultaneously imaging multiple objects. The foregoing and other objectives, features and advantages of the invention will be more readily understood upon consideration of the following detailed description of the invention, taken in conjunction with the accompanying drawings.

### BRIEF DESCRIPTION OF THE DRAWINGS

FIG. 1 is a pictorial view of a first embodiment of a microscope array adapted for use according to the present invention.

FIG. 2 is a pictorial view of a second embodiment of a microscope array adapted for use according to the present invention.

FIG. 3 is a plan view of an exemplary mechanism for producing relative movement between a microscope array, a detector array and multiple objects according to the present invention.

FIG. 4 is a pictorial view of a third embodiment of a microscope array adapted for use according to the present invention.

FIG. 5 is plan view of a microarray plate divided into four subgroups according to the present invention.

FIG. 6 is a plan view of a detector array according to the present invention.

FIG. 7 is a plan view of a microarray plate divided into four subsets according to the present invention, for use with the detector array of FIG. 6.

FIG. 8 is a pictorial view of a fourth embodiment of a microscope array adapted for use according to the present invention.

FIG. 9 is a plan view of a fifth embodiment of a microscope array adapted for use according to the present invention.

### DETAILED DESCRIPTION OF THE INVENTION

The present invention employs a microscope array having a plurality of microscope imaging elements arranged side-by-side. A microscope array has recently been developed wherein the imaging elements are arranged to image respective contiguous portions of a common object in one dimension while scanning the object line-by-line in the other dimension, in which case the microscope array is also known as an array microscope. Array microscopes may be used, for example, to scan and image entire tissue or fluid samples for use by pathologists. Individual imaging elements of array microscopes are closely packed, and have a high numerical aperture, which enables the capture of high-resolution microscopic images of the entire specimen in a short period of time by scanning the specimen with the array microscope. In the present invention a microscope array is used to image independent objects, or potions of a larger object, corresponding respectively to a plurality of microscope imaging elements in the array. While a high numerical aperture is desirable in some applications, close packing and scanning are not necessarily needed.

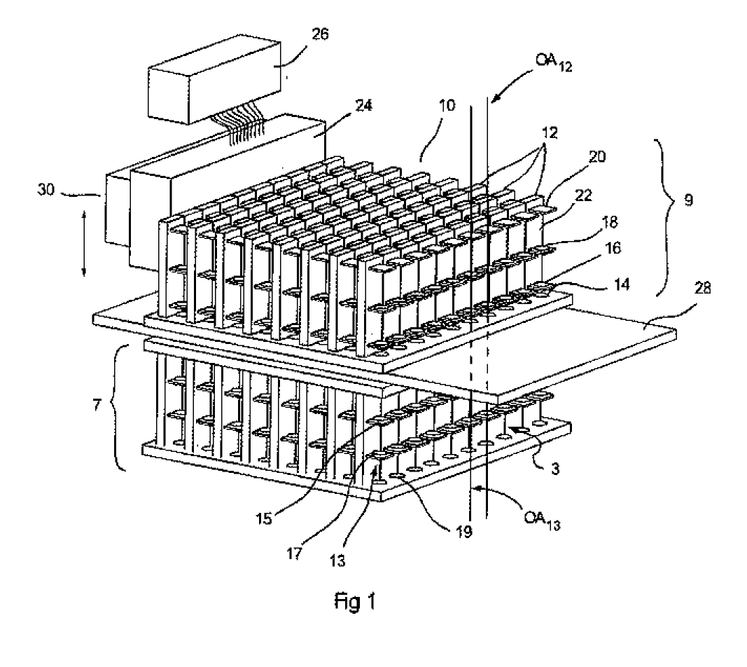

A first embodiment of a microscope array 10 adapted for use in the present invention is shown in FIG. 1. The microscope array 10 comprises an imaging lens system 9 having a plurality of individual imaging elements 12. Each imaging element 12 may comprise a number of optical elements, such as elements 14, 16, 18 and 20. In this example, the elements 14, 16 and 18 are lenses and the element 20 is an image detector device, such as a CCD array. More or fewer optical elements may be employed as is well understood in the art. The optical elements are mounted on a support 22 so that each imaging element 12 defines an optical imaging axis OA₁₂ for that imaging element.

The microscope array 10 is typically provided with a detector interface 24 for connecting the microscope array to a data processor or computer 26 which controls the data acquisition process, and acquires and stores the image data produced by the detectors of devices 20. An object, or an array of objects such as a microarray, is placed on a stage 28 for simultaneous imaging of discrete areas of an object, or respective individual objects in an array of objects. Preferably the stage may be moved with respect to the microscope array, under control of the data processor, so as to image simultaneously selected subsets of objects, or portions of an object. The array may be equipped with a linear motor 30 for moving the imaging elements together axially to achieve focus, though individual axial focusing may also be provided.

The microscope array 10 also includes a trans-illumination system 7, which is shown as a plurality of individual illumination elements 13 for illuminating respective objects, or portions of a larger object, each having respective spaced-apart optical axes OA₁₃. In this exemplary case elements 13 correspond one-to-one with the imaging elements 12, but single axis illumination may also be used. The illumination elements 12 may comprise a number of optical elements, such as the elements 15, 17 and 19. In this example, the elements 15 and 17 are lenses and the element 19 is a source of light, such as a light emitting diode. As for the imaging system, more or fewer optical elements may be employed to achieve desired illumination, as is well understood in the art. The optical elements of the illumination system may also be mounted on the support 22.

It is to be understood that epi-illumination may also be used with a microscope array according to the present invention. Also, the light sources may be integrated with the light detectors to achieve a desired image size and quality.

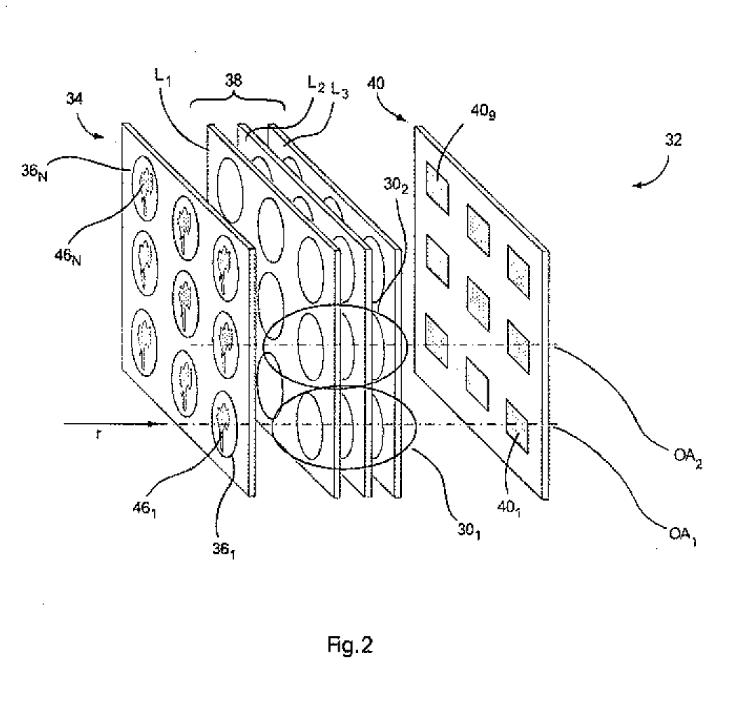

Turning to FIG. 2, a second embodiment 32 of a microscope array according to the present invention is shown. The microscope array 32 includes an imaging array 38, and a detector array 40, the individual elements 40₁, 40₂, 40₃ . . . 40_{N} of the detector array each comprising a two-dimensional array of light detectors. The microscope array 32 is particularly adapted to image a microarray plate 34 having an array of individual cells 36₁, 36₂, 36₃, . . . 36_{N}, where N is an integer which, in this example, equals 9. The cells 36 are provided for mounting or containing corresponding respective objects 46₁, 46₂, 46₃, . . . 46_{N}. In any case, an array of objects is mounted on a stage, such as stage 28 in FIG. 1, for simultaneous imaging by the microscope array 32.

The imaging array 38 may include any number of layers “L” of arrays of lenses or other optical elements such as polarizers, collimators, mirrors, and splitters. Three such layers L₁, L₂, and L₃, are shown for purposes of illustration. The imaging array 38 defines N imaging elements 30₁, 30₂, . . . 30_{N} for imaging, respectively, the N cells 36. Each imaging element defines a respective optical axis OA₁, OA₂, . . . OA_{N} and has an associated field of view that encompasses the corresponding cell 36.

Also corresponding to the N cells 36 and the N imaging elements 30, the detector array 40 includes N detectors 40₁, 40₂, 40₃, . . . 40_{N} for converting the images produced by the N imaging elements to associated electrical signals for input to the data processor for manipulation or video display. Where the amount of data accumulated during a single acquisition by the N detectors is significant, the data can be transferred into the processor while another microarray is being loaded.

It is an outstanding recognition of the present inventors that, since the objects, and therefore the cells, are discrete, they may be separated by any distances and yet still be imaged simultaneously with the microscope 32. Accordingly, there may be spaces, such as the spaces indicated as s₁ and s₂, between the cells, in contrast to the ordinary need in an array microscope to pack the imaging lens systems and detectors close together. A respective detector 40, imaging element 30, and cell 36 are all optically aligned to produce an image of a respective object 46 in the cell 36 on the detector 40 when the object is appropriately illuminated.

As an example of the operation of the imaging lens system to image the object 46₁ of the microarray, rays of light such as that referenced as “r” in FIG. 2 are produced by an illumination system (not shown) and transmitted through the object 46₁, through the imaging element system 30₁, and onto the detector 40₁. Rays “r” that are displaced from or angled with respect to the optical axis OA₁ are confined within a limiting aperture of the lens system 30₁ centered on the optical axis. Epi-illumination, wherein the rays of light are reflected or scattered from the object into the lens system, may also be employed, and the sources and detectors may integrated.

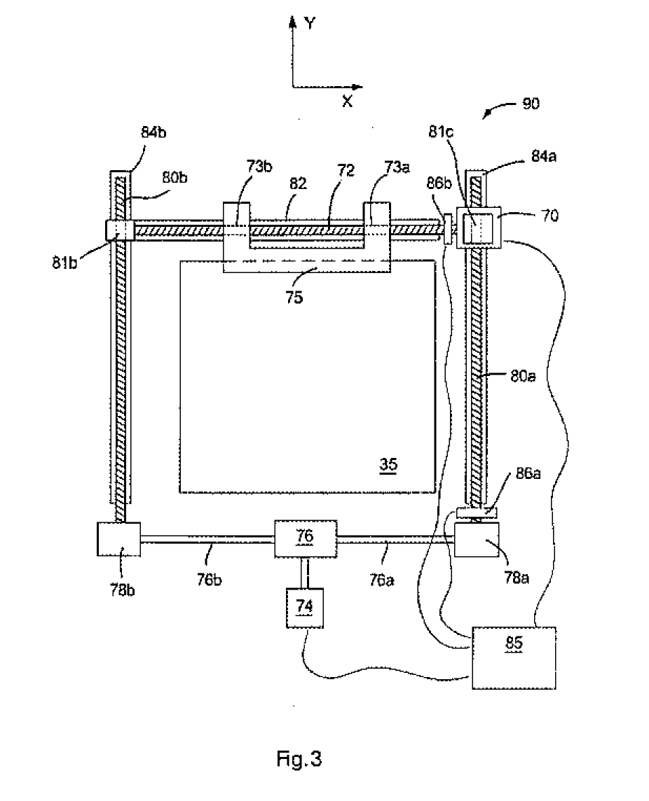

FIG. 3 illustrates an exemplary stage mechanism 90 that may be used for scanning objects according to the present invention. The stage mechanism 90 is used to move an object, or array of objects, and is particularly adapted for moving the microarray plate 34 shown in FIG. 2. In the stage mechanism 90, an “x” axis drive motor 70 turns a drive screw 72 that extends through threaded holes 73a, 73b in an attachment member 75 that supports and object or carrier 35. The attachment member 75 rides in the “x” direction on a cross-member 82. A “y” axis drive motor 74 turns two half-shafts 76a, 76b through a transmission 76. Each half-shaft is coupled by a crossed-gear box 78a, 78b to respective drive screws 80a, 80b similar to the screw 72. The drive screws 80 extend through threaded holes 81a, 81b through the cross-member 82 which in turn rides in the “y” direction on parallel support members 84a, 84b. A controller 85, responsive to the data processor 26, controls the motors 70 and 74, and is preferably provided with position feedback such as may be provided by encoders 86a, 86b at the screws 72 and, e.g., 80a. The stage mechanism preferably may be operated as to place the object, or object array, in a desired position with respect to the microscope array. Although the exemplary stage mechanism is described herein for purposes of completeness, it should be recognized that the particular stage mechanism is not critical to the invention and that a variety of other positioning and object-supporting mechanisms could be used without departing from the principles of the invention.

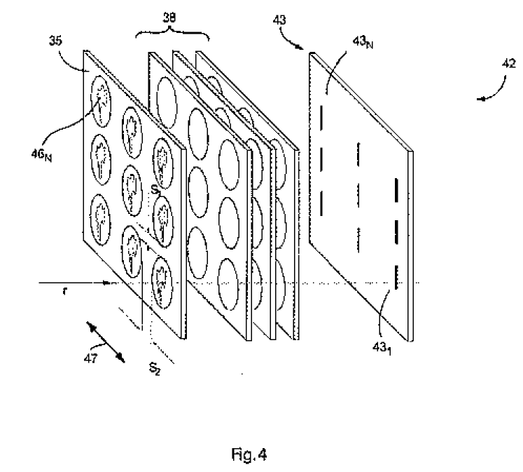

Scanning movements may be accomplished straightforwardly by moving the carrier 35 with respect to the imaging array 38 and the detector array 40, as shown by the example of FIG. 4. Alternatively, scanning may be accomplished by moving the imaging array 38 with respect to the microarray plate and the detector array, moving the detector array 40 with respect to the imaging array and the microarray plate, moving the imaging array and detector together with respect to the microarray plate, and moving the microarray plate and detector array together with respect to the imaging array. Moreover, scanning may be physical or may be virtual with the use of mirrors or other beam steering mechanisms as known in the art.

Turning to FIG. 4, a third embodiment 42 of a microscope array according to the present invention is shown, wherein an alternative method of scanning for parallel acquisition of image data is used according to the present invention. The microscope array 42 is similar to the microscope array 32, except a detector array 43 makes use of linear detector arrays 43₁, 43₂, 43₃, . . . 43_{N}, such as a linear array of charge-coupled devices or CCD's, rather than two-dimensional detector arrays as in FIG. 2. Accordingly, to scan the N objects with the detector array 43, the microscope array 42 provides for moving the stage 35 relative to the microscope array 42 perpendicular to the linear axes of the detectors 43, along the directions indicated by the arrows 47. However, the amount of movement required is defined by that required to scan just one of the objects, and is therefore not increased by adding more cells to the array. Thus, image data within a given cell or other object is acquired on a line-by-line basis, while multiple cells, or other objects, are imaged simultaneously.

Although the embodiments of FIGS. 1, 2 and 4 have all been explained in terms of regular arrays of imaging elements and respective objects, it is to be recognized that it is not necessary that the imaging elements or objects be arranged in a regular array or even with a consistent spatial period, i.e., on a regular grid pattern.

Any of the aforementioned microscope array embodiments 10, 32 and 42 may be employed as described above to image all N objects simultaneously. However, it may be necessary or desirable to divide the N objects into subsets and, while imaging simultaneously the objects in each subset, to image the subsets sequentially. This is necessary when there are fewer imaging elements and corresponding detectors than there are objects to be imaged, and may be desirable, for example, to lower the cost of the microscope array, or to meet physical constraints, such as the available size of the detectors.

Although there is no need for scanning where there is a one-to-one correspondence between objects to be imaged and imaging elements, and the detectors are themselves two-dimensional arrays, the relative positions of the microscope array and the object, or object array, must be changed sequentially where the number of imaging elements in the microscope array is less than the number of discrete object portions, or objects in an object array, to be imaged. This procedure is referred to herein as “stepping” the microscope array, wherein the controller 85 of FIG. 3 is appropriately adapted to control the motors 70 and 74 to produce stepping movements. The process of stepping the microscope array coupled with acquiring images for each of the different subsets is referred to below as “stepping and repeating.” Stepping and repeating may include within one cycle scanning according to the principles discussed above.

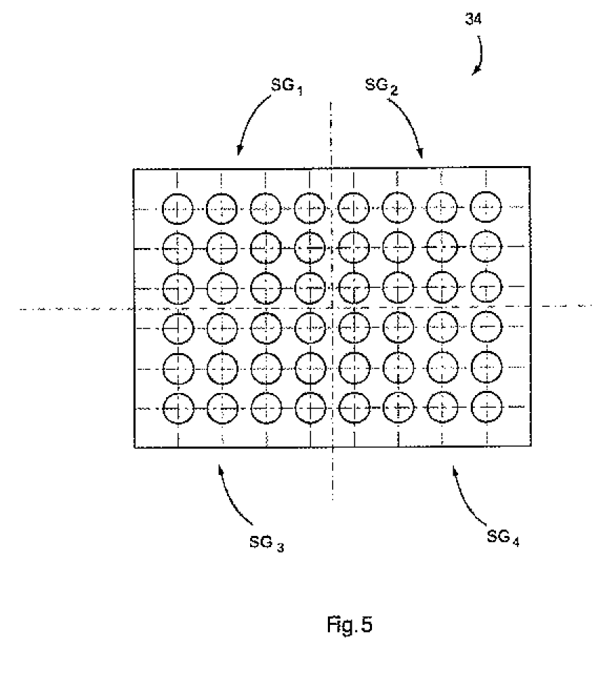

FIG. 5 shows an example of a microarray plate 34 divided into four subsets SG₁, SG₂, SG₃, and SG₄ that are referred to herein as subgroups because the objects in each subset are physically grouped together. The microscopes 10, 32 and 42 are adapted to step and repeat the imaging cycles described above at the four different locations of the subgroups SG. The simultaneous scanning of each subgroup being referred to herein as a “pass,” the subgroup SG₁ may be scanned in the first pass, SG₂ in the second pass, and so on. The subgroups may be imaged in any order, though the order is preferably selected to minimize the total stepping distance. Imaging subgroups is advantageous to decrease the size of the microscope array. While the step and repeat process may most rapidly be carried out with two-dimensional detectors associated with each imaging element and acquiring data in parallel, the detectors may also be linear arrays, in which case contiguous scanning line-by-line is also performed to acquire the image data for each discrete object or object portion.

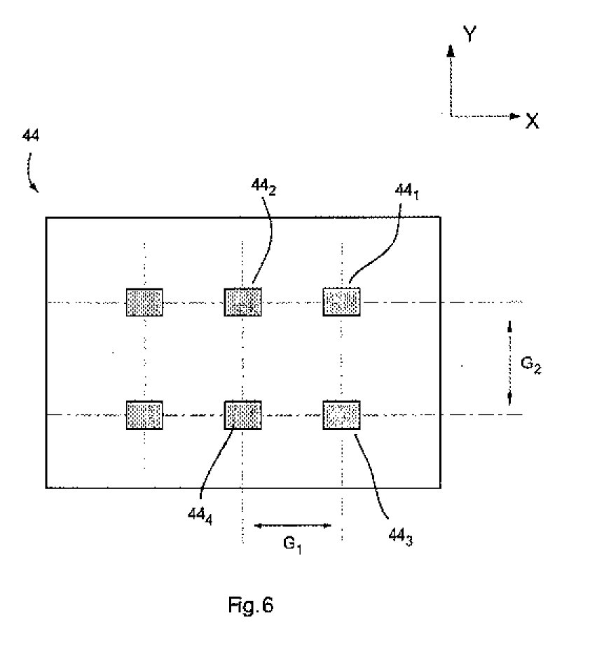

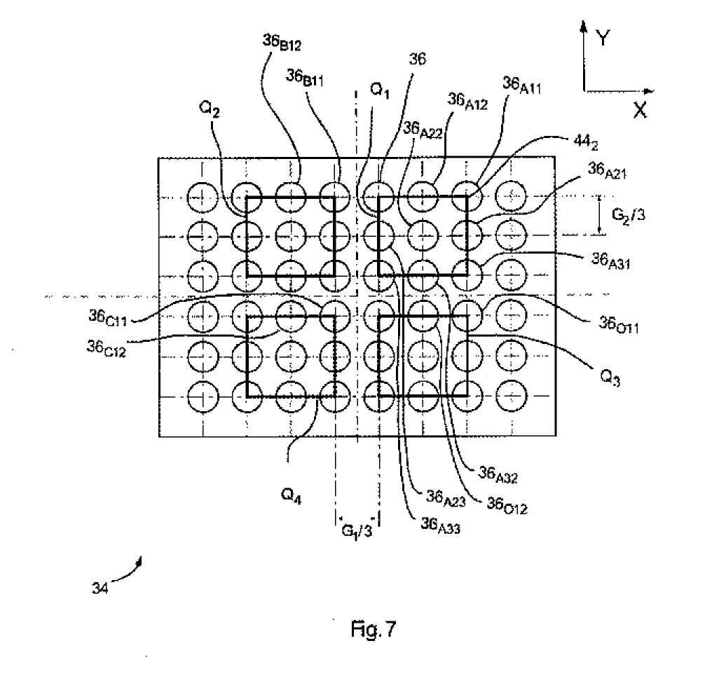

FIGS. 6 and 7 provide a more general example of simultaneous imaging of the subsets. As mentioned above, this is necessary when there are fewer imaging elements and corresponding detectors than there are objects to be imaged, and may be desirable, for example, to lower the cost of the array microscope, or to meet physical constraints, such as the available size of the detectors.

FIG. 6 shows a detector array 44 for use with a corresponding imaging element array 38 (not shown). The detector array 44 includes the four detectors shown as 44₁, 44₂, 44₃, and 44₄. The detectors are arranged on a grid spacing of “G₁” in the “x” direction and “G₂” in the “y” direction.

A microarray plate 34 for use with the detector array 44 is shown in FIG. 7. The microarray plate 34 includes cells 36 arranged on a grid spacing of “G₁/3” in the “x” direction and “G₂/3” in the “y” direction. A rectangular grid element “Q,” corresponding to the minimum grid spacing between adjacent detectors 44 in the detector array of FIG. 7, is shown registered to the grid pattern for the cells 36 of the microarray plate 34. The detector 44₁ is indicated as being registered particularly to the cell 36_{A11}. The grid element Q₁ defines a required unit of coverage of the microarray 34 that corresponds to the detector 44₁. The remaining detectors 44 have similar required units of coverage associated therewith for tiling the microarray 34.

In this example, the detector 44₁ images the cell 36_{A11} in a first pass of the microscope array. The same detector is also used to image the remaining eight cells in the rectangle Q in respective subsequent passes. For example, the detector 44₁ may image the cells 36_{A11}-36_{A33} in the following sequence: cell 36_{A12} in the second pass, and cell 36_{A13} in the third pass (corresponding to stepping three times in the negative “x” direction), thence to cell 36_{A23} in the fourth pass (corresponding to stepping once in the negative “y” direction), cell 36_{A22} in the fifth pass, 36_{A21} in the sixth pass, 36_{A31} in the seventh pass, 36_{A32} in the eighth pass, and 36_{A33} in the ninth pass, for a total of nine passes. Any other sequence may be used, though the order is preferably selected, such as that just described, to minimize the total stepping distance.

Where the detector array 34 is spatially periodic with a period G₁ in the “x” direction and G₂ in the “y” direction, the aforedescribed sequencing causes the detector 44₂ to image the objects in the cells defined by the grid element Q₂, and causes the detector 44₃ to image the objects in the cells defined by the grid element Q₃, and so on, to tile the microarray 34. Accordingly, the array comprising the cells 36_{A11}, 36_{B11}, 36_{C11}, and 36_{D11} describes a first subset of the cells that is imaged on the first pass, the array comprising the cells 36_{A12}, 36_{B12}, 36_{C12}, and 36_{D12} describes a second subset that is imaged on the aforedescribed second pass, and so on. It may be noted, by contrast with the subgroups discussed above, that the objects in the different subsets of FIG. 7 are intermingled rather than being physically grouped together, so that the areas encompassed by the subsets spatially overlap rather than being spatially distinct.

It may also be noted that within a given grid element Q, the array of cells 36 need not be spatially periodic, i.e., the cells 36 defined by a given grid element Q need not be centered on a regular grid pattern, provided all grid elements Q share the same pattern of cells, and the periodicity of the detector array 34 provides for stepping and repeating the patterns defined by the grid elements Q. Accordingly, for purposes herein, an “array” is any predetermined physical pattern and need not be regular or spatially periodic.

In the example of FIGS. 6 and 7, the grid spacing in the “x” direction for the detector array is three times that of the corresponding grid spacing for the microarray, and similarly the grid spacing in the “y” direction for the detector array is three times that of the corresponding grid spacing for the microarray. Multiplying these ratios provides the number of passes required to image every cell in the microarray with the detector array. It may be appreciated, therefore, that the resolution of the detector array 44 is traded-off, one-for-one, with the number of passes required to image all of the cells.

It has been mentioned above that it is not generally necessary, and it may not be particularly desirable, to space the cells apart any particular distance in a microscope array for simultaneously scanning multiple objects according to the present invention. However, where methods are employed such as those just described that rely on making multiple passes, it is then desirable again to pack the objects close together to limit the travel of moving parts of the microscope required for each pass.

The embodiments described above make use of imaging and detector arrays that have spacings between imaging and detector elements that correspond to the spacings provided between the corresponding objects to be imaged, such as they may be arranged by the microarray plate 42. These spacings may be on a regular grid or be non-regular; however, it has been assumed that the imaging and detector elements corresponding to a particular object are physically aligned.

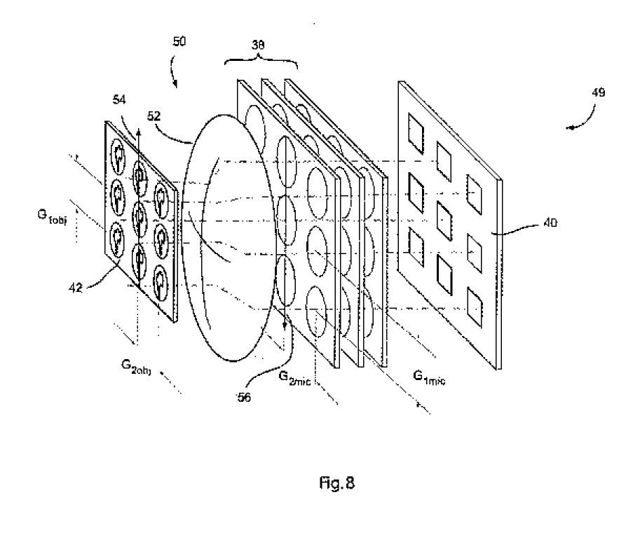

Alternatively, the invention may provide for altering either the actual or the virtual spacing between elements of the microscope to compensate for differences between these spacings and the corresponding spacings between objects. Turning to FIG. 8 for example, a fourth embodiment 49 of a microscope array according to this aspect of the present invention is shown. A matching optical system 50 may be provided between the microscope elements 38 and 40 and the microarray 42, to compensate optically for the difference between the grid spacings G_{1obj}, G_{2obj} and G_{1mic}, G_{2mic}, corresponding to the x and y grid spacings for the objects on the microarray plate and the microscope elements respectively. For the purpose of illustration, the matching optical system 50 is shown as a single lens 52 that magnifies or demagnifies the image of the microarray 42 to match the grid of the microscope array, as shown by object arrow 54 and image arrow 56. However, it is to be recognized that the matching optical system could be a multi-element system. The matching optical system 50 may also be placed between layers of the microscope to compensate for a difference in spacing between the elements of one of the layers of the microscope with respect to the elements of the other layer of the microscope, and may be placed between the microscope elements 38, on the one hand, and the detector array 40 on the other.

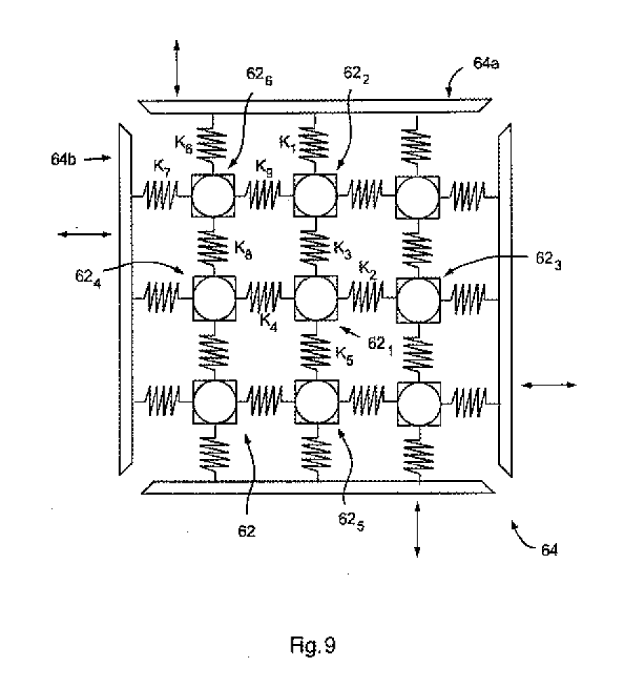

Turning to FIG. 9, a fifth embodiment 60 of a microscope array according to the present invention is shown. The microscope array 60 illustrates a means for actually altering the spacing between microscope elements 62 shown in plan view. Each element 62 is coupled to its nearest neighbor elements with a spring k. For example, the element 62₁ is coupled to nearest neighbor elements 62₂, 62₃, 62₄, and 62₅ respectively with identical springs k₂, k₃, k₄, and k₅. Elements on the outer periphery of the array 60 are symmetrically terminated by being coupled to movable rails 64. For example, the element 62₂ is coupled to the movable rail 64a through the spring k₁, which is identical to the spring k₃. The element 62₆, which is adjacent two of the movable rails 64a and 64b, is coupled to those rails respectively through springs k₆ and k₇, which are identical, respectively, with springs k₈ and k₉. For small movements of the rails in the directions of the corresponding arrows, such an “elastic” array provides for expanding or contracting the array 60 while retaining equal spacing between the elements 62. The array can be expanded or contracted as a mechanical alternative to providing the compensating optical system 50 discussed above.

While a simple embodiment 60 of an array microscope has been provided to illustrate the concept, the array may be provided with dissimilar springs, to provide for dissimilar spacings between elements and therefore a distortion of the array 60, or the springs may be replaced with mechanical actuators, such as linear positioning actuators, to adjust the spacings between particular elements 62 as desired.

While some specific embodiments of an array microscope for simultaneously imaging multiple objects have been shown and described, other embodiments according with the principles of the invention may be used to the same or similar advantage. It should be noted that radiations other than visible light may be employed without departing from the principles of the invention.

The terms and expressions which have been employed in the foregoing specification are used therein as terms of description and not of limitation, and there is no intention, in the use of such terms and expressions, to exclude equivalents of the features shown and described or portions thereof, it being recognized that the scope of the invention is defined and limited only by the claims that follow:

1. A method for simultaneously imaging multiple objects, comprising the steps of:
arranging a first plurality of objects into an object array;
providing a first plurality of microscopes with respective fields of view arranged in an array such that said microscopes are optically aligned respectively with said first plurality of objects for producing an array of respective first images thereof, each microscope of said first plurality of microscopes comprising multiple single-axis elements aligned along a respective optical axis of the microscope, each of said elements being a component only of said microscope; and
simultaneously imaging said first plurality of objects with said microscopes to produce said first images thereof by illuminating a corresponding array of respective image detectors optically coupled directly to said microscopes, said image detectors comprising respective arrays of photodetector elements, the size of said array of said image detectors and the size of said array of first images being substantially equal to or greater than the size of said object array.

2. The method of claim 1, further comprising simultaneously scanning said first plurality of objects to produce said first images thereof.

3. The method of claim 2 further comprising providing a linear array of detectors for capturing image data line-by-line as, during said scanning, relative movement occurs between said first plurality of objects and said linear array of detectors in a direction substantially perpendicular to said linear array of detectors.

4. The method of claim 1, further comprising arranging a second plurality of objects in a second array, providing a second plurality of microscopes with respective fields of view that are optically aligned respectively with said second plurality of objects for producing an array of respective second images thereof, and simultaneously imaging said second plurality of objects with said second plurality of microscopes aligned with said second plurality of objects to produce said second images thereof.

5. The method of claim 4, wherein said objects in said first and second arrays are respectively physically grouped together to provide two distinct subsets of objects.

6. The method of claim 5, further comprising simultaneously scanning the objects in said first and second pluralities of objects to produce said first and second images respectively.

7. The method of claim 4, wherein said steps of arranging result in the objects in said first and second arrays being physically intermingled to provide two overlapping subsets of objects.

8. The method of claim 7, further comprising simultaneously scanning the objects in said first and second pluralities of objects to produce said first and second images respectively.

9. The method of claim 1, wherein said fields of view of said microscopes substantially encompass said respective objects so as to produce respective first images of substantially the entirety of said objects.

10. The method of claim 9, wherein said objects are individual cells of a microarray.

11. A microscope array for simultaneously imaging a plurality of objects arranged in an object array, comprising:
a plurality of microscopes having respective spaced-apart fields of view and arranged into a corresponding array such that said microscopes may be optically aligned respectively with said plurality of objects for producing an array of respective images thereof, wherein each microscope of said plurality of microscopes comprises multiple single-axis elements aligned along a respective optical axis of the microscope, each of said elements being a component only of said microscope; and
a data acquisition element for simultaneously capturing image data from a plurality of said microscopes, said data acquisition element comprising a corresponding array of respective image detectors optically coupled directly to said microscopes, said image detectors comprising respective arrays of photodetector elements, the size of said array of said image detectors and the size of said array of images being substantially equal to or greater than the size of said object array.

12. The microscope array of claim 11, wherein said data acquisition element comprises an electronic data processor responsive to said detectors.

13. The microscope array of claim 11, wherein the microscope array further includes a mechanism for producing relative movement of at least one of (a) the object array, (b) said single-axis elements, and (c) said detectors.

14. The microscope array of claim 13, wherein said mechanism is adapted to produce said movement in discrete amounts.

15. The microscope array of claim 14, further comprising a controller for controlling said mechanism to produce said movement.

16. The microscope array of claim 13, wherein said mechanism is adapted to produce said movement in continuous amounts.

17. The microscope array of claim 16, further comprising a controller for controlling said mechanism to produce said movement.

18. The microscope array of claim 13, wherein said mechanism is adapted to produce said movement in discrete and continuous amounts.

19. The microscope array of claim 18, further comprising a controller for controlling said mechanism to produce said movement.

20. The microscope array of claim 11, wherein said fields of view of said microscopes substantially encompass said respective objects so as to produce respective first images of substantially the entirety of said objects, and wherein said objects are individual cells of a microarray.
